(19) United States
(12) Patent Application Publication
(10) Pub. No.: US 2021/0155035 A1
(43) Pub. Date: May 27, 2021

(54) SHIELDING ASSEMBLY FOR SIDE OF A TIRE

(71) Applicant: ARGONICS, INC., Gwinn, MI (US)

(72) Inventor: Jeremy Nylund, Marquette, MI (US)

(21) Appl. No.: 17/167,576

(22) Filed: Feb. 4, 2021

Related U.S. Application Data
(63) Continuation-in-part of application No. 16/006,334, filed on Jun. 12, 2018.
(60) Provisional application No. 62/518,356, filed on Jun. 12, 2017.

(51) Int. Cl. B60B 7/01; B60B 25/22

(52) U.S. Cl. CPC B60B 7/01; B60B 25/22

(57) ABSTRACT

The combination of: a wheel with a tire mounted on a rim; a mounting assembly that moves with the rim and defines in conjunction with the rim a mounting unit; a plurality of shielding components, each having a reinforcing element and attached to the mounting assembly to overlie a part of the tire at one side of the wheel; and a first fastener securing each shielding component to the mounting assembly. The mounting unit and each shielding component have axially overlapping and oppositely facing surfaces in confronting relationship that cooperate and thereby confine relative movement between the shielding components and the mounting unit.

### CROSS-REFERENCE TO RELATED APPLICATIONS

This application is a continuation-in-part of U.S. patent application Ser. No. 16/006,334 filed Jun. 12, 2018, which claims priority to U.S. Provisional Patent Application No. 62/518,356 filed Jun. 12, 2017.

### BACKGROUND OF THE INVENTION

### Field of the Invention

This invention relates to wheels with a rim mounted tire and, more particularly, to structure for shielding a side of the tire against puncture and wear from encountered environmental materials and objects.

### BACKGROUND ART

Rim mounted rubber tires are used on a wide range of vehicles. One particularly vulnerable part of these tires is the exposed sidewall region. While the main tread region may be made with a highly durable construction, the tire sidewalls are more prone to being compromised by being punctured, worn, etc. Damage to a tire sidewall may render the tire unusable and irreparable.

The above problem is not significant for vehicles designed for highway driving. However, this problem is common and costly in industries where vehicles are required to navigate rugged terrain and/or are likely to encounter sharp objects that may penetrate the tire sidewall.

Even if a sharp object is not encountered that effects penetration of puncture of a tire sidewall, progressive wear of the tire sidewall, as when regularly immersed in abrasive material, may necessitate tire replacement before its intended useful life period expires.

A number of systems have been devised to overlie part or all of a tire sidewall to minimize abrasive wear and the likelihood of penetration of the sidewall by a foreign object, such as a protruding rock and/or other hard environmental debris.

Designers of these systems have a number of objectives. First of all, the systems must be effective in terms of greatly reducing the incidence of unusual wear or failure due to a puncturing of the sidewall region of tires operating in the particular severe environment.

Second, the systems must be user friendly in the sense that they can be initially mounted and potentially repaired conveniently on site.

Third, the systems must be affordable to justify their purchase and ongoing maintenance.

Fourth, the systems must utilize materials that function effectively in many different environments which may differ in terms of the nature of the terrain and foreign objects that may be encountered in use and climate conditions. In the latter case, it must be taken into account that a piece of equipment might be utilized in tropical climates year round whereas in other locales it may be exposed to frigid conditions for a good portion of the operating life of the equipment. Temperature extremes may make certain shielding compositions either more penetrable in hot climates or more brittle in extremely cold climates.

Fifth, the system must be designed so as to remain consistently in an operative position on an associated wheel, while withstanding high impact forces and other forces encountered during operation that tend to compromise the protective component(s) and/or their connection to a wheel. This is particularly a challenge with small components that collectively produce a protective structure where the individual components may be made from lightweight material and have a limited area to accept fasteners.

The industry continues to be challenged to make a practical system that addresses some or all of the above objectives which, at times, are in competition with each other.

### SUMMARY OF THE INVENTION

In one form, the invention is directed to the combination of: a wheel; a mounting assembly; a plurality of shielding components; and at least a first fastener. The wheel has a turning axis, a rim, and a tire mounted to the rim for rolling against an underlying surface. The wheel has oppositely facing sides. The mounting assembly moves as one piece with the rim. The mounting assembly, in conjunction with the rim, defines a mounting unit. Each of the plurality of shielding components is attached to the mounting assembly in an operative position to overlie at least a part of the tire at one of the axially oppositely facing sides of the wheel. Each of at least one of the shielding components is made from a non-metal material and a reinforcing element. The first fastener connects the reinforcing element on each of the at least one shielding component to the mounting assembly to thereby maintain each of the at least one shielding component in a respective operative position. The mounting unit and each of the at least one shielding component have axially overlapping and oppositely facing surfaces in confronting relationship. The oppositely facing surfaces, on each of the at least one shielding component, in respective operative positions, cooperate and thereby confine relative movement between each of the at least one shielding component and the mounting unit.

In one form, the oppositely facing surfaces are radially oppositely facing surfaces, with one of the radially oppositely facing surfaces on the reinforcing element.

In one form, the mounting unit and each of the at least one shielding component have first and second pairs of axially overlapping and oppositely facing surfaces in confronting relationship, with the oppositely facing surfaces in each of the pairs cooperating to thereby confine relative movement between each of the at least one shielding component and the mounting unit.

In one form, the first and a second fastener connect the reinforcing element on each of the at least one shielding component to the mounting assembly to thereby maintain each of the at least one shielding component in a respective operative position.

In one form, there is a groove in one of: a) the mounting unit; and b) the reinforcing element on each of the at least one shielding component, and a bead on the other of: a) the mounting unit; and b) the reinforcing element on each of the at least one shielding component. The bead defines one of the cooperating oppositely facing surfaces with the other of the cooperating oppositely facing surfaces bounding the groove for each of the at least one shielding component.

In one form, the bead is defined by the mounting unit.

In one form, the oppositely facing surfaces are radially oppositely facing surfaces.

In one form, the reinforcing element on each of the at least one shielding component has a body with an arcuate shape at a radial innermost edge as viewed along the wheel turning axis.

In one form, the reinforcing element on each of the at least one shielding component directly abuts to the mounting unit.

In one form, the reinforcing element on each of the at least one shielding component is embedded in the non-metal material.

In one form, the reinforcing element on each of the at least one shielding component has a body with first and second portions that are angled with respect to each other as viewed in cross section defined by a plane containing the wheel turning axis.

In one form, the reinforcing element on each of the at least one shielding component has a discrete opening with a volume in which a quantity of the non-metal material resides.

In one form, the reinforcing element on each of the at least one shielding component has a body with a stepped axial thickness.

In one form, each of the at least one shielding component has an arcuately-shaped, radially innermost edge with a circumferential extent between ends of the arcuately-shaped edge. The reinforcing element extends over a majority of the circumferential extent of a respective one of the radially innermost edge of the at least one shielding component.

In one form, the reinforcing element on each of the at least one shielding component extends to adjacent each of the ends of the arcuately-shaped edge on a respective one of the at least one shielding component.

In one form, the mounting assembly is a ring-shaped component welded to the wheel rim and defines at least one pre-threaded bore to threadably engage the first fastener.

In one form, each of the at least one shielding component has a radially outermost tip and first and second surfaces that converge towards the radially outermost tip.

In one form, the radially outermost tip on each of the at least one shielding component abuts to, or is immediately adjacent to, the one of the axially oppositely facing sides of the wheel.

In one form, the body on the reinforcing element on each of the at least one shielding component has a radially outer edge that is substantially straight as viewed along the wheel turning axis.

In one form, the first fastener has a head and a shaft. The body on the reinforcing element on each of the at least one shielding component has a discrete cutout to receive the head on the first fastener.

### BRIEF DESCRIPTION OF THE DRAWINGS

FIG. 1 is a schematic representation of a shielding assembly, according to the invention, operatively connected to a conventional wheel consisting of a tire mounted on a rim;

FIG. 2 is a front elevation view of one form of a conventional wheel with which the inventive shielding assembly can be used;

FIG. 3 is a side elevation view of the wheel in FIG. 2;

FIG. 4 is a side elevation view of an exemplary mounting assembly used to maintain the inventive shielding assembly on a wheel;

FIG. 5 is a perspective view of the mounting assembly in FIG. 4;

FIG. 6 is a plan view of the mounting assembly in FIGS. 4 and 5;

FIG. 7 is a fragmentary, partial cross-sectional view showing the connection of one form of a shielding component, on the inventive shielding assembly, to a wheel rim through the mounting assembly;

FIG. 8 is a reduced, side elevation view of a shielding assembly, made up of multiple shielding components as shown in FIG. 7;

FIG. 9 is a side elevation view showing two shielding components, as in FIGS. 7 and 8, relatively situated preparatory to being operatively connected to each other;

FIG. 10 is a perspective view of one of the shielding components in FIGS. 7-9;

FIG. 11 is a view of the shielding component in FIG. 10 from a different perspective;

FIG. 12 is a fragmentary, perspective view of a wheel showing one of the shielding components operatively connected thereto;

FIG. 13 is a schematic representation of cooperating connectors between operatively connected shielding components as shown in FIGS. 7-12;

FIG. 14 is an exploded perspective view of a conventional wheel with a modified form of shielding assembly, according to the invention;

FIG. 15 is an enlarged, front, elevation view of a mounting assembly on the shielding assembly in FIG. 14;

FIG. 16 is a cross-sectional view of the mounting assembly taken along line 16-16 of FIG. 15;

FIGS. 17-20 are different enlarged, perspective views of one of the shielding components making up the shielding assembly in FIG. 14;

FIG. 21 is a view as in FIG. 14 with the shielding assembly operatively connected to the wheel;

FIG. 22 is an exploded, perspective view of a conventional wheel with a further modified form of shielding assembly, according to the invention;

FIG. 23 is an enlarged, perspective view of one of the shielding components on the shielding assembly in FIG. 22;

FIG. 24 is a front elevation view of the shielding component in FIG. 23;

FIG. 25 is a cross-sectional view of the shielding component taken along line 25-25 of FIG. 24;

FIG. 26 is a bottom view of the shielding component in FIGS. 23-25;

FIG. 27 is a cross-sectional view of the components in FIG. 22 in assembled relationship;

FIG. 28 is an enlarged view of the components within the circle in FIG. 27;

FIG. 29 is an enlarged, perspective view of a reinforcing element on the shielding component in FIGS. 22-28;

FIG. 30 is an enlarged view of the reinforcing element in FIG. 29 from a different perspective; and

FIG. 31 is a schematic representation generically depicting a mounting unit and shielding component with axially overlapping and oppositely facing surfaces thereon that are in confronting relationship and cooperate to confine relative movement between the shielding components and mounting unit.

### DETAILED DESCRIPTION OF THE PREFERRED EMBODIMENT

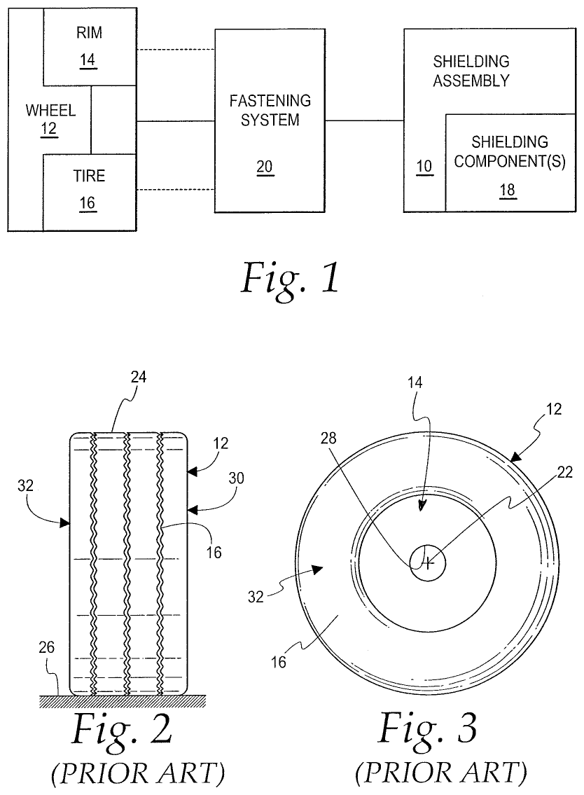

In FIG. 1, a shielding assembly, according to the present invention, is shown at 10 for use on a wheel 12 of the type having a rim 14 and a tire 16 mounted on the rim 14.

The shielding assembly 10 consists of at least one shielding component 18 that is secured to the wheel 12 through a fastening system 20.

The schematic showing of the components in FIG. 1 is intended to encompass wheels with different constructions as well as virtually an unlimited number of different forms of the shielding assembly 10, described in one exemplary form below. The schematic representation is intended to encompass the specific form described herein and others involving different components and different cooperating arrangements therebetween. As just one example, the shielding assembly 10 might be maintained on the wheel 12 through the fastening system 20 that engages the rim 14 and/or the tire 16.

One specific form of the wheel 10 of FIG. 1 is shown in FIGS. 2 and 3. The wheel 10 has a turning axis 22 and a tire 16 with a treaded, annular, outer surface 24 that rolls against an underlying surface 26. The tire 16 is mounted to a conventional type rim 14, typically with a mounting opening 28 that accommodates a vehicle axle end (not shown).

The wheel 12 has axially oppositely facing sides 30, 32.

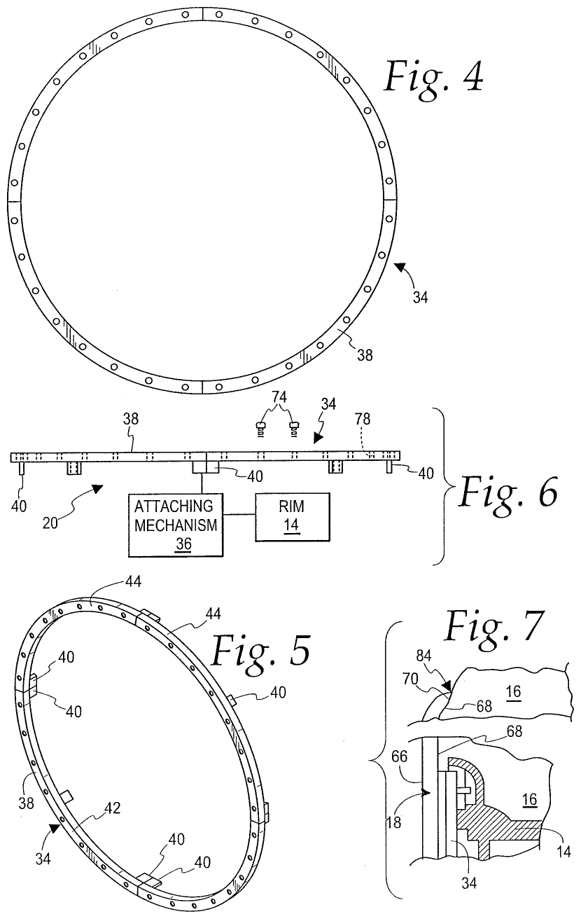

The fastening system 20 is made up in part of a mounting assembly 34, as shown in FIGS. 4-7, that is attached to the rim 14 through an attaching mechanism 36, shown schematically in FIG. 6.

In this embodiment, the mounting assembly 34 consists of an annular ring 38 with a plurality of circumferentially spaced, axially projecting mounting tabs 40. While the attaching mechanism 36 may take a number of different forms, in one preferred form, the attaching mechanism 36, which may include the tabs 40, is in the form of welds through which the tabs 40 and/or a main annular body 42, making up the mounting assembly 34, can be fixed to the rim 14.

As depicted, the body 42 consists of a plurality of joined, arcuate segments 44 that cooperatively produce the annular shape in FIGS. 4 and 5. The tabs 40 can be connected on adjacent segments 44 to form the ring-shaped body 42 into a unitary, rigid piece. Alternatively, the segments 44 might be individually secured, as by welding, to the rim 14 to move as one piece therewith. Still further, the annular ring 38 may be defined by a single piece. In any event, the mounting assembly 34 is fixed to move as one piece with the rim 14.

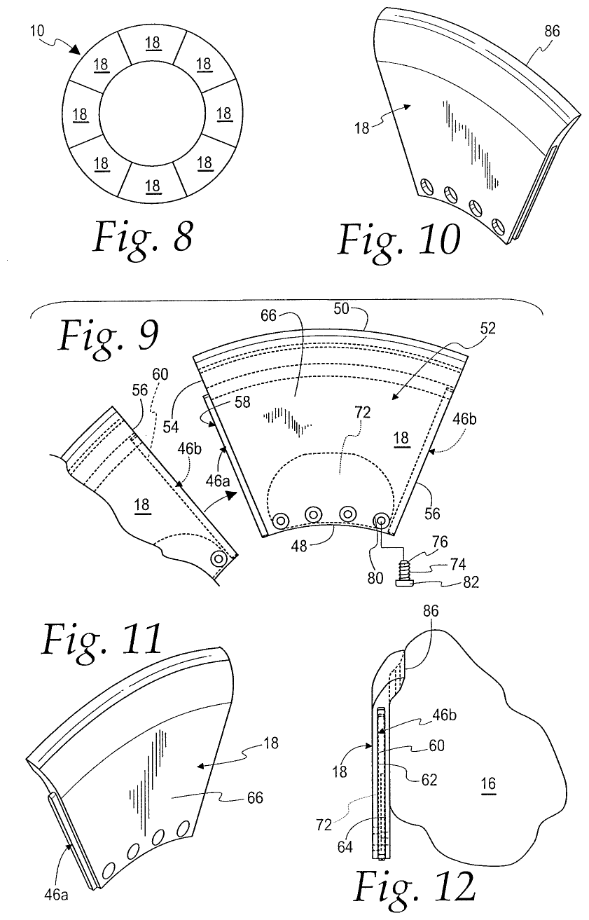

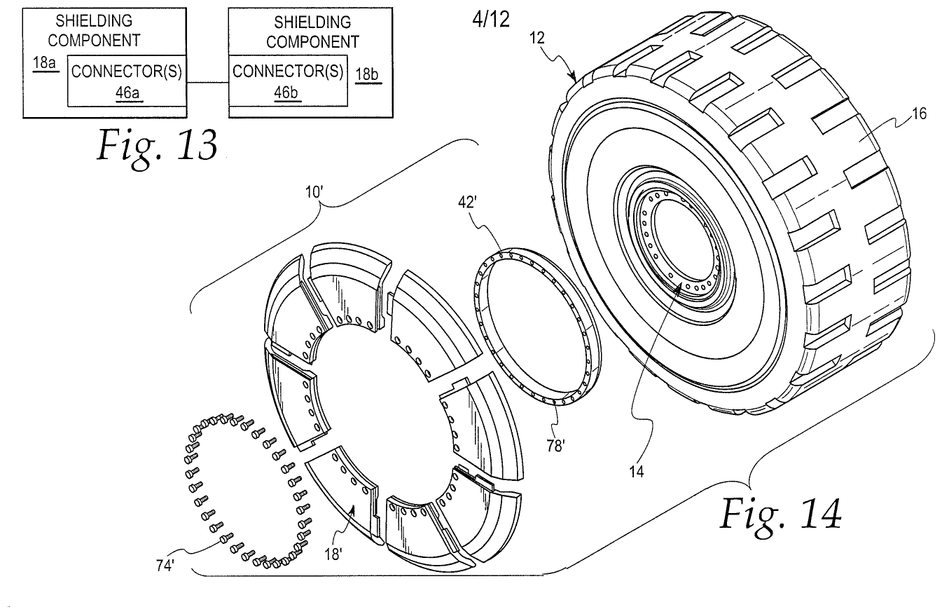

The shielding assembly 10 may be made from a single piece or, as shown in FIGS. 8-12 and schematically in FIG. 13, by combining multiple shielding components 18.

The schematic showing in FIG. 13 contemplates very different forms of connectors 46a, 46b that cooperate between adjacent shielding components 18a, 18b, that are representative of two adjacent shielding components 18, as shown in FIG. 8, that cooperatively produce an annular shape for the shielding assembly 10.

While the operatively connected shielding components 18 are not limited to the form shown, in the depicted form, each has substantially the same shape—a truncated sector of a circle with radially inner and outer edge portions 48, 50, as viewed along the turning axis 22.

A body 52 of each shielding component 18 is bounded additionally by angled edges 54, 56, each extending between the edge portions 48, 50.

On each shielding component 18, a connector 46a, as shown schematically in FIG. 13, is provided at the edge 54, with a connector 46b provided at the edge 56.

Adjacent shielding components 18 are joined as shown particularly in FIG. 9. The shielding components 18 are relatively positioned so that the circumferentially oppositely facing edges 54, 56, on the shielding components 18 to be operatively connected, are adjacent to each other. In this position, the connector 46a aligns with the connector 46b, which has a complementary shape.

More specifically, the connector 46a is in the form of an elongate rib 58 with a radially extending length. The connector 46b is in the form of a complementary receptacle 60 bounded in part by axially oppositely facing surfaces 62, 64. With the rib 58 extended into the receptacle 60, the edges 54, 46 preferably abut or are in close proximity. The cooperating connectors 46a, 46b maintain a predetermined axial relationship between the shielding components 18, and as depicted a flush relationship between the front surfaces 66 thereof.

The surface 68, facing oppositely to the surface 66, conforms closely, or at least nominally, to a sidewall surface 70 on the tire 16 with the shielding assembly 10 operatively positioned, as shown in FIG. 7.

The bodies 52 of the shielding components 18, in one preferred form, are made from a non-metal material. A most preferred form of non-metal material is urethane, although this is not required. Urethane has the ability to absorb impacts and readily deforms under such impacts without fracturing in even frigid environments. Urethane is also highly resistant to abrasive wear. At the same time, urethane can be used to readily mold the bodies 52 into a desired shape that conforms to the tire 16 at the sidewall region 70.

To rigidify the non-metal body 52, and to facilitate mounting of each shielding component 18, a reinforcing element 72 is embedded in the molded body material, at least at the region near the inner edge portion 48 whereat the shielding components 18 are secured to the mounting assembly 34.

As seen particularly in FIGS. 9 and 12, the reinforcing element 72 has a generally oval shape and extends radially on the order of one-third the radial extent of the body 52. The reinforcing element 72 spans a majority of the extent of the inner edge portion 48 between the connectors 46a, 46b. As depicted, each reinforcing element 46a, 46b extends substantially fully up to its respective connector 46b, but is slightly spaced from the connector 46a so as not to weaken the same.

To secure the shielding components 18, a plurality of threaded fasteners 74 are used. Each fastener 74 extends through the material making up the body 52 and the reinforcing element 72. A threaded shank 76 engages within a threaded bore 78 in the body 42 of the mounting assembly 34.

As depicted, for stability and rigidity, multiple fasteners 74 are used to connect each reinforcing element 72 to the mounting assembly 34. As depicted, four such fasteners 74 are accommodated at equally spaced intervals along the edge portion 48.

Seats 80 are formed through the surface 66 of the body 52 to accept each fastener head 82 whereby a countersunk arrangement results and the head 82 is at least nominally flush with the surface 66.

The shielding components 18 are preferably configured so that with the fasteners 74 tightened, the surfaces 68 are drawn against the sidewall surface 70, thereby potentially avoiding the creation of a gap in the region at 84 where the top edge 86 of each body 52 is located. By avoiding such gap formation, buildup of foreign material may be minimized that might progressively wedge the body 52 outwardly from the sidewall surface 70.

The degree of coverage of the sidewall surface 70 may change depending on the desired end objective of the shielding assembly 10. Preferably, the shielding assembly 10 overlies at least that part of the tire 16 that is most vulnerable to being compromised through puncture and/or wear.

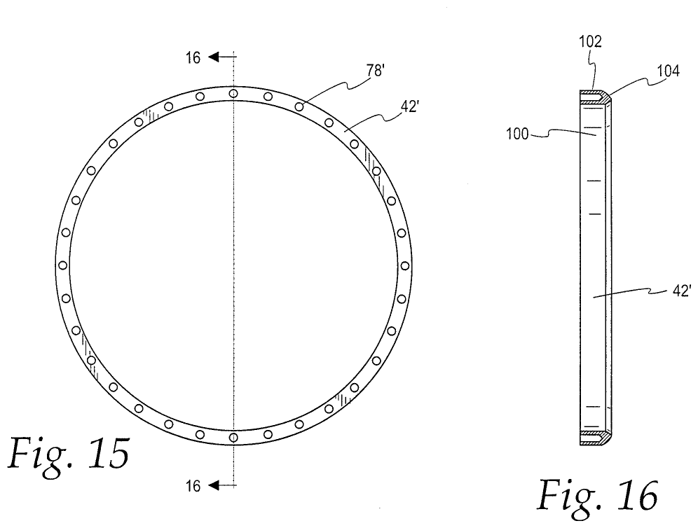

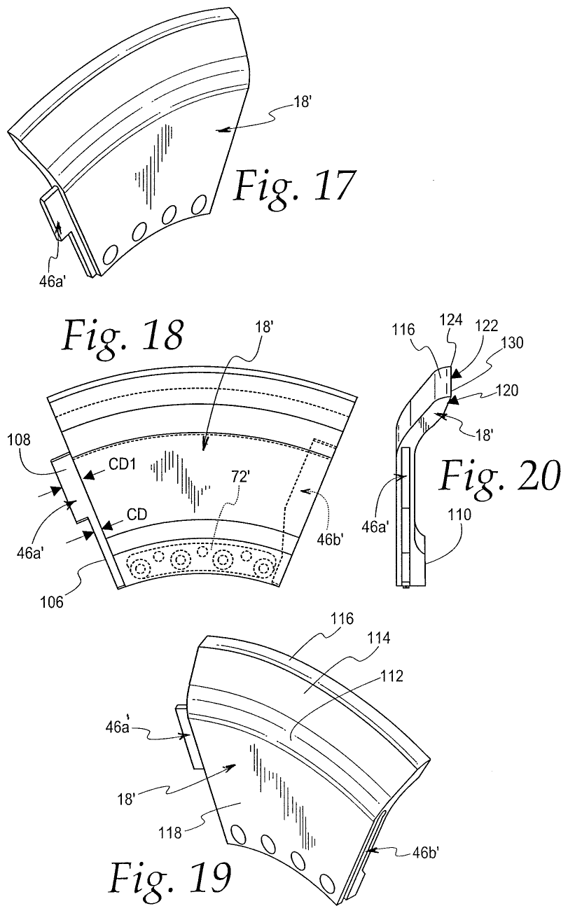

In FIGS. 14-21, a modified form of shielding assembly, according to the invention, is shown at 10′ on the wheel 12 having the rim 14 upon which the tire 16 is mounted.

The shielding assembly 10′ functions substantially in the same way as the shielding assembly 10, described above. The differences between the shielding assembly 10, 10′ will be described below with corresponding parts numbered the same but with a “′” designation.

Whereas the mounting assembly 34 depicted has a body 42 made up of a plurality of arcuate segments 44, the body 42′ is formed as a single piece that is configured to adapt to a particular rim configuration. More specifically, the body 42′ has a diameter and cross-sectional shape that will be complementary to a surface on the hub 14 to facilitate nesting of the body 42′ thereagainst and affixing of the same thereto, as by welding. As seen in FIG. 16, the radially inwardly and outwardly facing surfaces 100, 102, respectively, on the body 42′, as well as the connecting portion 104, have continuous, uninterrupted shapes around the full circumferential extent of the body 42′.

The shielding components 18′ differ from the shielding components 18 by reason of the configuration of the corresponding connectors 46a′, 46b′.

The connector 46a′ has a generally “L” shape with a rib portion 106 having a projecting circumferential dimension CD approximately equal to the corresponding dimension of the connector 46a. Radially outwardly from the rib portion 106, the connector 46a′ has a widened portion 108 with a circumferential dimension CD1 that is greater than the dimension CD.

With this arrangement, a greater circumferential overlap of the connectors 46a′, 46b′ is permitted radially outside of the reinforcing element 72′. This configuration of connectors 46a′, 46b′ allows the circumferential extent of the reinforcing element 72′ to be greater, thereby potentially contributing to a more rigid and stably mounted structure.

The individual shielding components 18′ are secured to the body 42′ using fasteners 74′ extending through the shielding components 18′, including reinforcing elements 72′ embedded therein, and into accommodating threaded bores 78′ in the body 42′.

The reinforcing element 72′ is shown with a lesser radial extent than the corresponding reinforcing element 72 and is also embedded in an axially thickened portion 110 of the shielding component that extends radially inwardly and outwardly slightly beyond the reinforcing element 72′. The thickened portion 110 gives the shielding components 18′ greater rigidity and provides a more solid foundation for the embedded reinforcing element 72′.

Further, the exposed surface region of each shielding component 18′ has a series, and in this case three, flat segments 112, 114, 116, as viewed from the ends of the shielding component 18′. Each of the segments 112, 114, 116 is angled with respect to the adjacent segment(s) and the flat, axially facing surface 118 on the insert 18′.

With this construction, and that in the earlier described embodiment, as viewed from the FIG. 20 perspective, a cantilevered finger 120 is formed that is pressed against the side of the tire 16 and is allowed to deflect axially outwardly as the fasteners 74′ are tightened. This causes conforming of the contact region at 122 on the finger 120 against the tire 16, thereby to provide a neat appearance and avoid migration of foreign matter between the shielding assembly 10′ and the tire 16. In FIG. 20, the contact region can be seen to include a relatively sharp edge 124 where the segment 116 and a surface 130 facing the tire 16 converge.

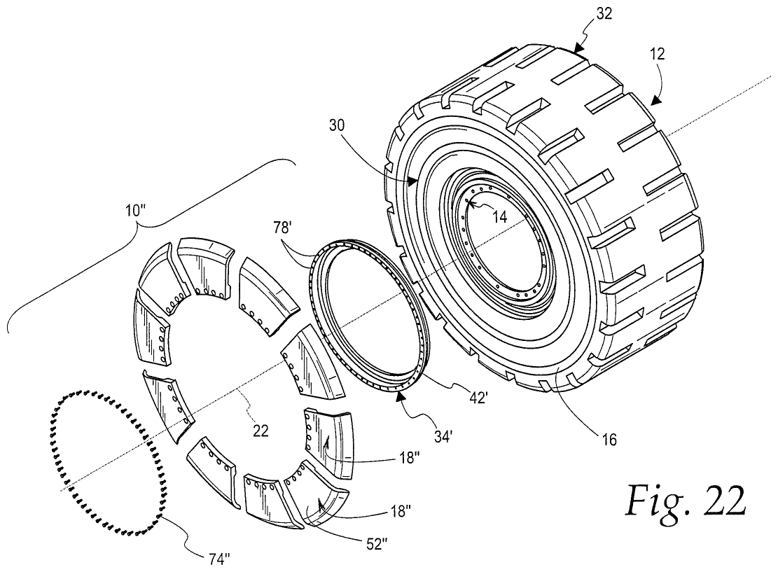

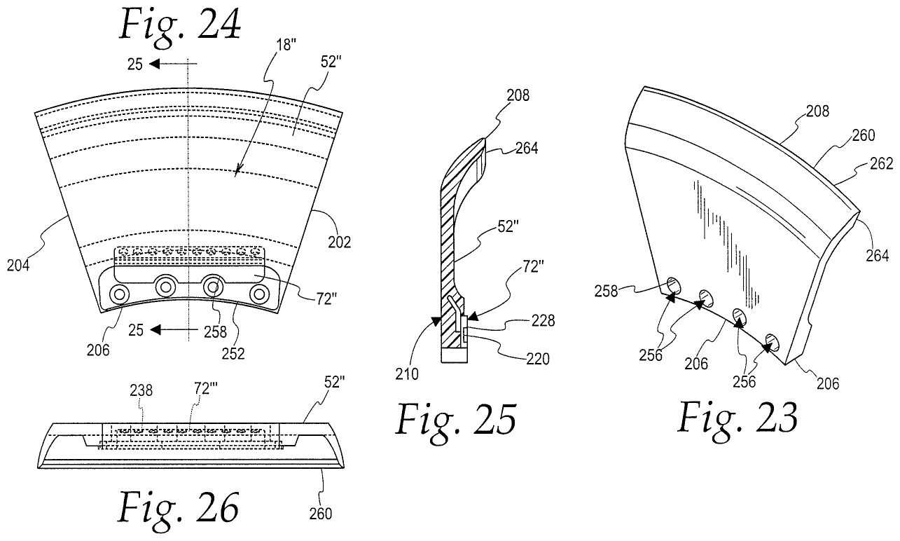

A further modified form of shielding assembly, according to the present invention, is shown at 10″ in FIGS. 22-30 in combination with the aforementioned wheel 12, consisting of the rim 14 with the tire 16 mounted on the rim 14.

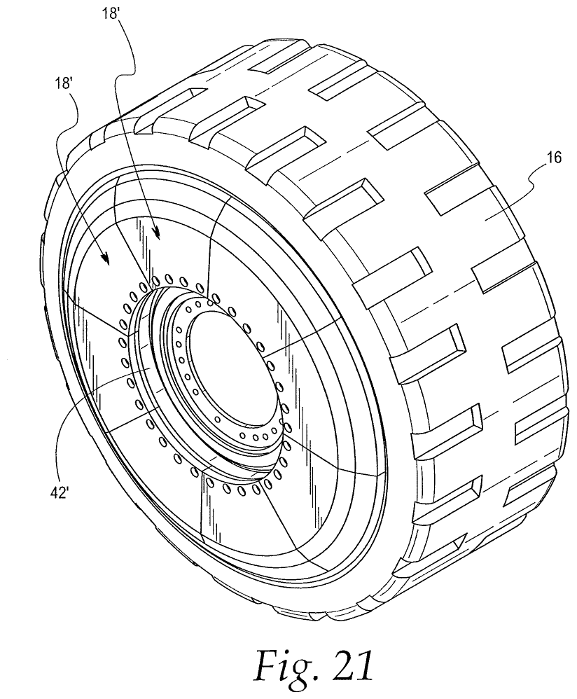

While not required, in this embodiment, the shielding assembly 10″ utilizes the mounting assembly 34′ with the body 42′ thereof formed as a single piece that is configured to adapt to the rim 14 to assume the relationship as in FIG. 21, wherein the body 42′ can be suitably fixed, as by welding, to the rim 14. The body 42′ has the aforementioned threaded bores 78′ spaced regularly around the wheel turning axis 22.

The mounting assembly may assume many different forms and be attached to the rim 14 in different manners, with the mounting assembly 34′ depicted only exemplary in nature.

Each of multiple shielding components 18″ is secured to the body 42′ through fasteners 74″, such that the shielding components 18″, in operative positions, cooperatively produce an annular shape at the side 30 of the wheel 12 that faces axially oppositely to the side 32.

The shielding components 18″ have the same general outline as the shielding components 18, 18′, as viewed along the wheel turning axis 22, with the exception that circumferentially oppositely facing edges 202, 204 on the body 52″ on each shielding component 18″ abut, or are proximate to, edges 202, 204 on adjacent shielding components 18″ without any circumferential overlap of the adjacent shielding components 18″ as in prior embodiments. Overlap could be incorporated into this design as well.

The body 52″ has radially inner/top and outer/bottom edges 206, 208, respectively. A mounting region 210 is provided adjacent to the inner edge 206. The mounting region 210 is axially thickened to allow firm embedding therein of the reinforcing element 72″.

As in earlier embodiments, the reinforcing element 72″ rigidifies the mounting region 210 which, like most, if not all, of the remainder of the body 52″, is made from a non-metal material, such as urethane, and allows for a more positive mounting/securement of the shielding component 18″ to a mounting unit 212, consisting of the aforementioned mounting assembly 34′ and the rim 14.

As depicted generically in FIG. 31, the mounting unit 212″, intended to encompass the mounting unit 212 and variations thereof, and shielding components 18″, are constructed so that there is at least one surface 214 on the mounting unit 212″ that is in axially overlapping relationship with at least one surface 216 on each shielding component 18″, which surfaces 214, 216 face oppositely and are in confronting relationship with the shielding component 18″ in its operative position. In this confronting relationship, the surfaces 214, 216 cooperate to confine relative movement between the shielding component 18″ and the mounting unit 212″.

The generic showing in FIG. 31 is intended to encompass the specific forms as described herein, as well as virtually an unlimited number of variations of the basic components depicted and their interaction.

In the exemplary form shown in FIGS. 22-30, the mounting unit 212 defines a bead 218 which nests in a groove 220 on the reinforcing element 72″. The groove 220 extends fully between circumferentially spaced ends 222, 224 of a body 226 on the reinforcing element 72″. The groove 220 may be milled in the body 226, which is preferably a metal material such as steel.

With the reinforcing element 72″ embedded in the body 52″, an axially facing surface 228 is directly exposed to the mounting unit 212. This allows the bead 218 on the mounting unit 212 to be directed axially into the groove 220.

The bead 218 and groove 220 have generally matched arcuate shapes and relative radial dimensions matched so that the bead 218 can be pressed into the groove 220 to make a reasonably snug fit without significant interference.

With this arrangement, the reinforcing element 72″ on the mounting unit 212 and shielding component 18″ have separate pairs of axially overlapping and oppositely facing surfaces that are in confronting relationship. More specifically, a radially inwardly facing surface 216a, on the reinforcing element 72″ and bounding the groove 220, faces radially oppositely to a surface 214a on the mounting unit 212.

A radially outwardly facing surface 216b, bounding the groove 220 on the reinforcing element 72″, faces oppositely to a radially inwardly facing surface 214b on the bead 218. With this arrangement, the reinforcing element 72″ directly abuts to the mounting unit 212.

With the shielding component 18″ in its operative position on the mounting unit 212″, the surfaces 214a, 216a; 214b, 216b cooperate to confine relative movement between the shielding component 18″ and the mounting unit 212. That is, these surfaces interact to effectively cause an interlocking relationship that avoids skewing of the reinforcing element 72″ relative to the mounting unit 212 with the fasteners 74″ extending through the reinforcing element 72″ and into the mounting assembly 34′, as described in greater detail below. These surfaces 214a, 216a; 214b, 216b interact to thereby effectively control radial shifting between each shielding component 18″ and the mounting unit, thereby reducing, or eliminating, radial load application on the tightened fasteners 74″.

While the surfaces 214a, 214b; 216a, 216b face radially in the depicted embodiment, this is not a requirement. Further, the confronting surfaces 214a, 241b; 216a, 216b may abut at all times or be brought into a confronting relationship under forces tending to skew the operative positions of the shielding components 18″.

Further, it should be understood that the arrangement of the bead 118 and groove 220 could be reversed to perform the same basic function.

In this embodiment, the body 226 of the reinforcing element 72″ has an arcuate shape at a radial innermost edge 230. The body 226 of the reinforcing element 72″ has a radially outer edge 232 that is substantially straight as viewed along the wheel turning axis 22.

The body 226 further has a generally overall rectangular shape, as viewed along the wheel turning axis 22, with a longer dimension between the ends 222, 224. The body 226 further has a stepped axial thickness with a radial inner portion 234 with a thickness T1 and a radial outer portion 236 with a thickness T2 that is substantially greater than the thickness T1.

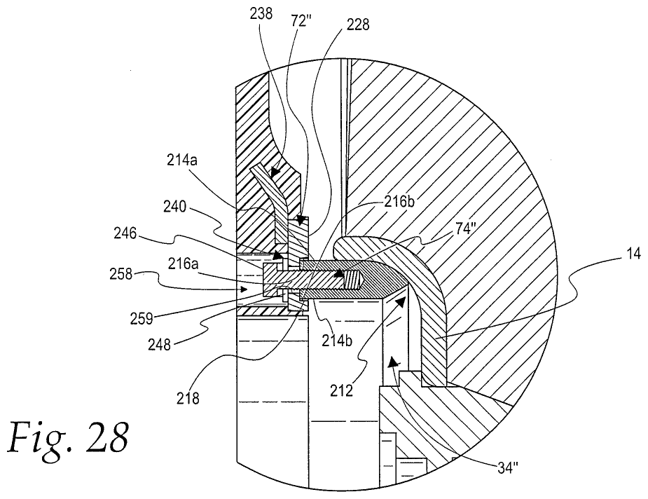

The body 226 has a generally rectangularly-shaped extension portion 238 that has a thickness approximately equal to T2-T1 and is angled with respect to a portion 240 of the body 226 that has the stepped thickness. The angled relationship is seen clearly in FIG. 28, which is a cross-sectional view as seen orthogonal to a plane containing the wheel turning axis 22.

This construction produces various angled portions, surfaces, and edges that rigidify the non-metal material in the mounting region 210 and positively maintain a fixed relationship between each reinforcing element 72″ and the non-metal material of the body 52″, to provide a more stable mount and avoid unwanted deformation of the body 52″ in use, or detrimental shifting of the non-metal material in the body 52″ relative to the reinforcing element 72″.

For further positive embedding of the reinforcing element 72″, discrete openings 242 are provided in the portion 238, with each opening 242 defining a volume within which a quantity of the non-metal body material resides.

Discrete cutouts 244 are formed in the body 226 whereat it has the thickness T2 to accommodate a head 246 and washer 248 on each fastener 74″. Each cutout 244 allows the head 246 and washer 248 on each fastener 74″ to bear axially against the surface 250 defined by the body 226 whereat it has the thickness T1.

As seen most clearly in FIGS. 24 and 28, an arcuately-shaped edge 252 is defined at the inner end 206 of the body 52″. The edge 230 of the body 226 on the reinforcing element 72″ is generally matched to the curvature of the edge 252. The reinforcing element 72″ extends along the edge 252 over a majority of the circumferential extent thereof between the edges 202, 204. As depicted, the reinforcing element 72″ extends to adjacent each of the ends of the edge 252 at the edges 202, 204.

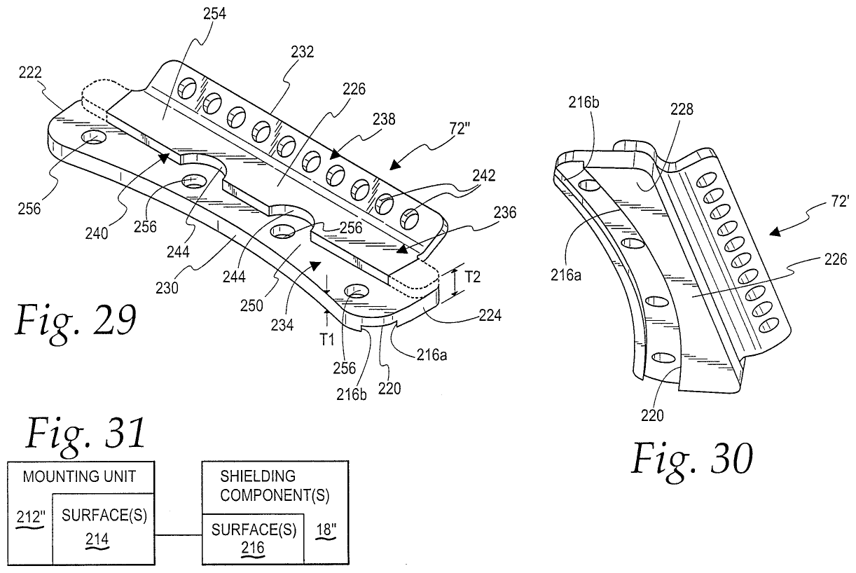

The surface 254, continuing into the extension portion 238, may extend circumferentially fully between the ends 222, 224, as shown in dotted lines in FIG. 29, or may terminate a slight distance therefrom as shown in solid lines.

Each shielding component 18″ is secured in place by directing the fasteners 74″ through openings 256, in this case four in number, at equal circumferential spacing. The openings 256 have a stepped diameter with a larger diameter portion 258 and a smaller diameter portion 259 to allow axial recessed placement of the fastener heads 246 and bearing of the fastener head 246 directly against the reinforcing element 72″.

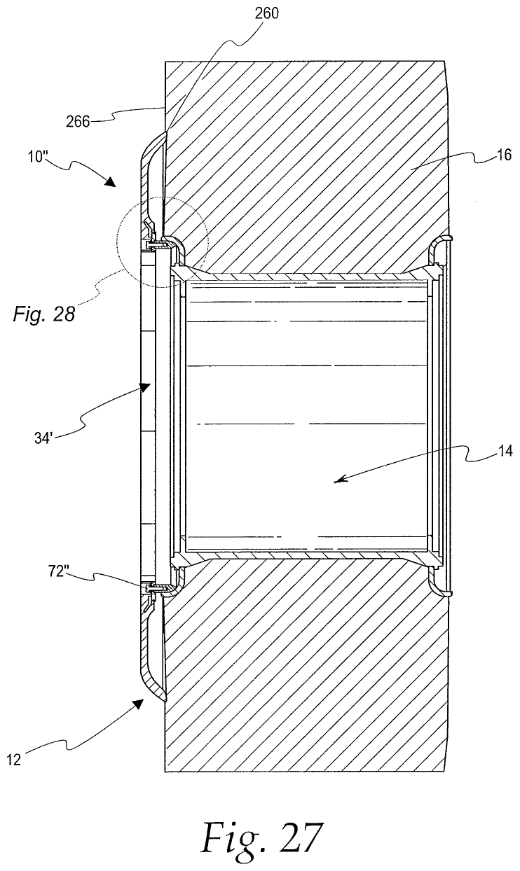

In this embodiment, the shielding components 18″ have a radially outermost tip 260 with surfaces 262, 264 converging theretowards. As seen most clearly in FIG. 27, the tip 260 directly abuts to, or is immediately adjacent to, the tire surface 266. By tightening the reinforcing elements 72″ into place and thereby securing the shielding components 18″ in their operative positions, the tips 260 engage the tire surface 266 and are slightly deformed, whereby there is a residual force applied by the tips 260 on the tire surface 266. This avoids migration of foreign material to between the tips 260 and the tire surface 266.

The foregoing disclosure of specific embodiments is intended to be illustrative of the broad concepts comprehended by the invention.

1. In combination:
a wheel having a turning axis, a rim, and a tire mounted to the rim for rolling against an underlying surface,
the wheel having oppositely facing sides;
a mounting assembly that moves as one piece with the rim and defines in conjunction with the rim a mounting unit;
a plurality of shielding components, each attached to the mounting assembly in an operative position to overlie at least a part of the tire at one of the axially oppositely facing sides of the wheel,
wherein each of the at least one of the shielding components is made from a non-metal material and a reinforcing element; and
a first fastener connecting the reinforcing element on each of the at least one shielding component to the mounting assembly to thereby maintain each of the at least one shielding component in a respective operative position,
wherein the mounting unit and each of the at least one shielding component have axially overlapping and oppositely facing surfaces in confronting relationship, with each of the at least one shielding component in a respective operative position, that cooperate and thereby confine relative movement between each of the at least one shielding component and the mounting unit.

2. The combination according to claim 1 wherein the oppositely facing surfaces are radially oppositely facing surfaces, with one of the radially oppositely facing surfaces on the reinforcing element.

3. The combination according to claim 1 wherein the mounting unit and each of the at least one shielding component have first and second pairs of axially overlapping and oppositely facing surfaces in confronting relationship with the oppositely facing surfaces in each of the pairs cooperating to thereby confine relative movement between each of the at least one shielding component and the mounting unit.

4. The combination according to claim 1 wherein the first and a second fastener connect the reinforcing element on each of the at least one shielding component to the mounting assembly to thereby maintain each of the at least one shielding component in a respective operative position.

5. The combination according to claim 1 wherein there is a groove in one of: a) the mounting unit; and b) the reinforcing element on each of the at least one shielding component, and a bead on the other of: a) the mounting unit; and b) the reinforcing element on each of the at least one shielding component, wherein the bead defines one of the cooperating oppositely facing surfaces with the other of the cooperating oppositely facing surfaces bounding the groove for each of the at least one shielding component.

6. The combination according to claim 5 wherein the bead is defined by the mounting unit.

7. The combination according to claim 5 wherein the oppositely facing surfaces are radially oppositely facing surfaces.

8. The combination according to claim 1 wherein the reinforcing element on each of the at least one shielding component has a body with an arcuate shape at a radial innermost edge as viewed along the wheel turning axis.

9. The combination according to claim 1 wherein the reinforcing element on each of the at least one shielding component directly abuts to the mounting unit.

10. The combination according to claim 1 wherein the reinforcing element on each of the at least one shielding component is embedded in the non-metal material.

11. The combination according to claim 1 wherein the reinforcing element on each of the at least one shielding component has a body with first and second portions that are angled with respect to each other as viewed in cross section defined by a plane containing the wheel turning axis.

12. The combination according to claim 10 wherein the reinforcing element on each of the at least one shielding component has a discrete opening with a volume in which a quantity of the non-metal material resides.

13. The combination according to claim 1 wherein the reinforcing element on each of the at least one shielding component has a body with a stepped axial thickness.

14. The combination according to claim 1 wherein each of the at least one shielding component has an arcuately-shaped, radially innermost edge with a circumferential extent between ends of the arcuately-shaped edge and the reinforcing element extends over a majority of the circumferential extent of a respective one of the radially innermost edge of the at least one shielding component.

15. The combination according to claim 14 wherein the reinforcing element on each of the at least one shielding component extends to adjacent each of the ends of the arcuately-shaped edge on a respective one of the at least one shielding component.

16. The combination according to claim 1 wherein the mounting assembly is a ring-shaped component welded to the wheel rim and defining at least one pre-threaded bore to threadably engage the first fastener.

17. The combination according to claim 1 wherein each of the at least one shielding component has a radially outermost tip and first and second surfaces that converge towards the radially outermost tip.

18. The combination according to claim 17 wherein the radially outermost tip on each of the at least one shielding component abuts to, or is immediately adjacent to, the one of the axially oppositely facing sides of the wheel.

19. The combination according to claim 8 wherein the body on the reinforcing element on each of the at least one shielding component has a radially outer edge that is substantially straight as viewed along the wheel turning axis.

20. The combination according to claim 13 wherein the first fastener has a head and a shaft and the body on the reinforcing element on each of the at least one shielding component has a discrete cutout to receive the head on the first fastener.
